(19) United States
(12) Patent Application Publication
(10) Pub. No.: US 2026/0237898 A1
(43) Pub. Date: Aug. 13, 2026

(54) System and Electronically Controllable Reflector

(71) Applicant: SIEMENS AKTIENGESELLSCHAFT, München (DE)

(72) Inventors: Andreas HOFMANN, Wien (AT); Lukas Walter MAYER, Wien (AT); Leopold RESEL, Wien (AT); Martin SCHIEFER, St. Poelten (AT)

(21) Appl. No.: 19/154,217

(22) PCT Filed: Jan. 30, 2024
(86) PCT No.: PCT/EP2024/052179

§ 371 Date: Aug. 6, 2025

(30) Foreign Application Priority Data
Feb. 8, 2023 (EP) 23155666

(51) Int. Cl. H01Q 3/46; H01Q 1/24; H01Q 3/28

(52) U.S. Cl. CPC H01Q 3/46; H01Q 1/24; H01Q 3/28

(57) ABSTRACT

An electronically controllable reflector includes at least one reflector element, each having at least a first antenna element, which is configured to receive a reception signal as an input signal with a first polarization, and an amplifier device, which is configured to electronically amplify the input signal and to output it as an output signal, and at least a second antenna element, which is configured to transmit the output signal with a second polarization as a transmission signal, and a control device, which is configured to control the magnitude and/or phase of the output signal using an electronic control device to form a controllable antenna characteristic of the reflector, where the second polarization differs from the first polarization.

### CROSS-REFERENCE TO RELATED APPLICATIONS

This is a U.S. national stage of application No. PCT/EP2024/052179 filed 30 Jan. 2024. Priority is claimed on European Application No. 23155666.3 filed 8 Feb. 2023, the content of which is incorporated herein by reference in its entirety.

### BACKGROUND OF THE INVENTION

### 1. Field of the Invention The invention relates to an electronically controllable reflector and to a system comprising the electronically controllable reflector.

### 2. Description of the Exemplary Embodiments

An electronically controllable reflector (known as a “reflective intelligent surface” or “RIS”) can be used to improve wireless communication at higher frequencies, such as 20 GHz and above, and when there are obstacles between a transmitter and a receiver. A RIS usually comprises a plurality of antenna elements that are generally uniform in size and geometry. The antenna elements are arranged geometrically on the surface of a substrate, generally in accordance with specific rules. For example, circular antenna elements are arranged in a hexagonal pattern at a spacing of 0.8 wavelengths.

An antenna element receives the incident power wave from the transmitter with a certain gain in accordance with the respective antenna characteristics. This energy is reflected by electronics within the element and modified in amplitude and/or phase. The control of the electronics in the individual elements is selected such that the sum of the individual reflections from the antenna elements combine constructively at the receiver.

By using an electronically controllable reflector, communication between the transmitter and receiver can be ensured even in the case of a non-line-of-sight connection. The range of wireless communication is determined, for example, by the signal level plan, i.e., the sum of the power losses from the transmitter to the receiver, taking into account the transmit power, the receiver sensitivity, and the noise power. A signal level plan also includes the reflection losses introduced by the electronically controllable reflector.

The technical objective is to minimize the reflection losses of the electronically controllable reflector and, where possible, to achieve a reflection gain.

The prior art includes a number of technical approaches for minimizing the losses introduced by an electronically controllable reflector and increasing the reflector's reflection gain:
Deployment of a large RIS surface with many individual antenna elements;
Use of individual high-efficiency antenna elements, for example, having low ohmic losses and providing high antenna gain;
Deployment of control electronics for the individual antenna elements with low reflection losses or even amplification;
Joint optimization of the control settings of the individual antenna elements to achieve optimal superposition of the field strength of the reflections from the individual antenna elements at the location of the receiver.

The problem is that all of these approaches are subject to limitations and constraints, and further improvements are being sought.

In prior art systems, there is a latent tendency toward self-oscillation due to amplification in the RIS control electronics. To date, it has often been necessary to reduce the gain to such an extent that no oscillation tendency remains. Consequently, although this served to compensate for losses in the RIS, only very small gains could be selected beyond this.

This resulted in limitations, such as transmit-receive isolation, which is defined as the ratio between the signal injected into the radiating element and the signal reflected back from the radiating element. In this context, the radiating element may also include directional couplers, isolators, and the like.

There is also a limitation with respect to inter-element isolation, i.e., the isolation from neighboring RIS antenna elements.

The achievable isolation values are low and highly dependent on the immediate environment. Particularly at millimeter-wave frequencies above 20 GHz, manufacturing and component tolerances also have a significant impact on isolation.

### SUMMARY OF THE INVENTION

In view of the foregoing, it is an object of the invention to provide a simple and efficient solution for overcoming the disadvantages of the prior art.

This and other objects and advantages are achieved in accordance with the invention by an electronically controllable reflector comprising at least one reflector element, which in turn comprises:
at least one first antenna element which is configured to receive a received signal as an input signal with a first polarization, and
an amplifier device which is configured to electronically amplify the input signal and output it as an output signal, and
at least one second antenna element which is configured to transmit the output signal as a transmit signal with a second polarization, where the second polarization differs from the first polarization, and
a control device which is configured to control the output signal in magnitude and/or phase using electronic control means to form a controllable antenna characteristic of the reflector, where the control device is further configured to receive a provided polarization control signal, where the amplifier device comprises a bidirectional signal amplifier that has two adjustable amplification directions and is configured to set the active amplification direction of the bidirectional signal amplifier in accordance with the polarization control signal.

This allows significantly higher isolation to be achieved, which in turn enables the amplification in the RIS elements to be significantly increased compared to the prior art.

The second polarization is preferably orthogonal to the first polarization, i.e., in the case of a linear polarization, preferably rotated by 90°, or for a circular polarization, rotated in opposite directions, such as left-hand rotation for the first polarization and right-hand rotation for the second polarization, or vice versa. This advantageously decouples the input channel and output channel of the antenna element.

As long as the gain is lower than the isolation, RIS stability, i.e., oscillation-free operation, can be achieved. This applies to both transmit-receive isolation and inter-element isolation.

The amplifier device comprises a bidirectional signal amplifier that can amplify signals either in the receive direction or back in the transmit direction.

The transmitted and received signals have different polarizations. However, it is clear in the present context that, in general, the polarizations of the signals can also be subject to various unwanted transmission effects, such as reflections. These unwanted effects are not considered separately in the present context, and the aforementioned difference in the polarization of the two signals is not relevant to the inventive feature in which, as part of the method, the signal with the second polarization is distinct from the signal with the first polarization.

The bidirectional amplifier switched by a control signal thus makes it possible to adapt the polarization in a simple manner when the direction of transmission is reversed, i.e., when a receiver switches to transmit mode, via a control signal from the respective transmitter that indicates to the reflector the polarization in which transmission is to take place, thereby keeping system complexity low and enabling simple and efficient bidirectional communication with changing polarization by means of the reflector.

The RIS can also be configured to shape the antenna characteristic of the reflector such that an attenuation of the radio signals between transmitter, reflector, and receiver is set to be as low as possible, which can be achieved by targeted selection of individual antenna elements and appropriate adjustment of their control with respect to magnitude and/or phase.

The electronically controllable reflector can comprise a large number of reflector elements, for example, 10, 50, 100, or more.

The antenna elements can be realized in different arrangements. For example, the antenna elements for reception and transmission can be arranged alternately to form the reflector.

Alternatively, two reflectors can be arranged next to one another. One of these reflectors serves as a receiver with antenna elements having a first polarization, and the other reflector serves as a transmitter with antenna elements having a second polarization, or the other reflector can be mounted rotated by 90° relative to the receiver in the case of linear polarization. This solution enables high amplification to be achieved, simultaneously with stable operation, while avoiding amplifier oscillation.

In addition, the number of antenna elements can be reduced while maintaining the same reflector effectiveness. For example, a gain of 3 dB halves the number of elements required, or rather the area required for the RIS is halved.

The smaller number of elements required increases the beam width of the directional characteristic of the RIS in the direction of the receiver. This means that less precise “aiming” is required, movements within the spatial setup have less effect, and locating radio participants, for example, by scanning in two spatial angles, requires fewer iterations and is therefore faster.

The solution is also advantageous in terms of optimizing energy consumption.

Electronic control means for controlling signals in magnitude and/or phase are known from the prior art; examples include electronic phase shifters, voltage dividers or electronic amplifiers in digital or analog design, with digital phase shifters, for example, allowing two or more states to be controlled.

In an embodiment of the invention, the reflector is structured to operate at an operating frequency of at least 20 GHz. Particularly at RIS operating frequencies above 20 GHz, a sufficiently large number of antenna elements can be realized.

In another embodiment of the invention, the at least one first antenna element and the at least one second antenna element are formed by a common antenna structure.

When bidirectional amplifiers are used instead of unidirectional amplifiers, the former being installed in alternating RIS elements, time-based control can be used to enable the RIS to receive horizontally and reflect vertically at one time, and operate with the reverse polarization at another time. The advantage here is that if the RIS knows which polarization is currently arriving as the input signal, additional elements configured accordingly in terms of polarization can contribute to amplification.

From the perspective of the radio system, no significant difference in channel characteristics is observable between uplink and downlink. There are no restrictions on the radio system used.

Furthermore, from the point of view of the radio system, it is advantageous to use a specific polarization because simple end devices often only support one polarization, or there are environmental conditions that favor or degrade a given polarization. Accordingly, the bidirectionally amplifying RIS enables the best connection to be used in each case.

A further enhancement is provided by control electronics, which can act purely passively, on the one hand, and operate in an amplifying manner (unidirectionally and/or bidirectionally), on the other.

The advantage of this solution is that it is possible to choose whether amplification and thus more supply power is required, or not. The RIS can be set and operated in an energy-optimized manner while maintaining sufficient performance. This property is particularly relevant for applications with high availability, i.e., 24 hours a day, 365 days a year operation.

This allows the reflector to be preset to a preferred polarization plane and reception losses can be reduced.

Electronic means for adjusting the polarization are known in the prior art, such as the use of separate feed points on a corresponding antenna, for example, a patch antenna, or the use of orthogonally arranged dipole antennas.

The objects and advantages are also achieved in accordance with the invention by a system comprising a radio transmitter for transmitting a data transmit signal and electronic means for controlling the polarization of the data signal, an electronically controllable reflector for reflecting the data transmit signal, a radio receiver for receiving the reflected data signal, and a system control device connected to the transmitter via a communication means, where the radio transmitter is configured to set a predetermined polarization using its electronic means and to transmit information about this polarization to the system control device via the communication means, and the system control device is configured to set the polarization at the reflector when receiving the data signal using the respective electronic means for setting the polarization.

This makes it possible to preset the reflector to a preferred polarization, thereby reducing reception losses.

In a further embodiment of the invention, the system comprises a first radio transmitter in accordance with the inventive system and a second radio transmitter, as well as a first radio receiver in accordance with the inventive system and a second radio receiver, where the first radio transmitter and the first radio receiver form a first transceiver, and the second radio transmitter and the second radio receiver form a second transceiver, and a controllable reflector in accordance with the inventive system, which is configured to connect the first transceiver to the second transceiver via a wireless link using the reflector, and the first radio transmitter is configured to transmit a first data signal with a first polarization at a first point in time, and the second radio transmitter is configured to transmit a second data signal with a second polarization at a subsequent second point in time, where the second polarization differs from the first polarization.

The reflector can be structured such that the first transceiver transmits and receives using the first polarization and the second transceiver transmits and receives using the second polarization.

This means that extending the radio system with an RIS does not require any modification or adaptation of the existing transmission technology between the transceivers. They can continue to use the same antennas for transmitting and receiving, and thus also the same polarizations.

In another embodiment of the invention, the transmitter is configured to transmit polarization information relating to the first polarization to the controllable reflector in accordance with the invention, and the reflector is configured to receive the polarization information and adjust the amplification direction of the bidirectional signal amplifier so that it corresponds to the first polarization.

Using the bidirectional signal amplifier provides a simple way to adjust the polarization to match the polarization of the signal transmitted by the transmitter.

In other words, this allows the transmission path in the combined antenna to become the reception path of the combined antenna, and allows the reception path to become the transmission path of the combined antenna.

In the combined antenna, a first polarization direction is provided for one switchable transmit/receive path, and a second polarization direction is provided for the second switchable transmit/receive path, where the first polarization direction differs from the second polarization direction, and the first polarization direction and the second polarization direction are preferably orthogonal to one another.

This formulation, as an embodiment of the invention, can also be understood as an independent system, separate from the system descriptions given above.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will now be explained in more detail with reference to an exemplary embodiments illustrated in the accompanying drawings, in which:

FIG. 1 shows a symbolic representation of an electronically controllable reflector in accordance with the invention;

FIG. 2 shows block diagram of the electronically controllable reflector in accordance with the invention;

FIG. 3 shows a representation of an antenna element in accordance with the prior art;

FIG. 4 shows an exemplary embodiment of an antenna element with an inserted unidirectional amplifier and two antenna ports for different polarizations in accordance with an embodiment of the invention;

FIG. 5 shows an exemplary embodiment of two antenna elements, each with an inserted unidirectional amplifier and two antenna ports for different polarizations in accordance with an embodiment of the invention;

FIG. 6 shows an exemplary embodiment of an antenna element with an inserted bidirectional amplifier and two antenna ports for different polarizations in accordance with an embodiment of the invention.

### DETAILED DESCRIPTION OF THE EXEMPLARY EMBODIMENTS

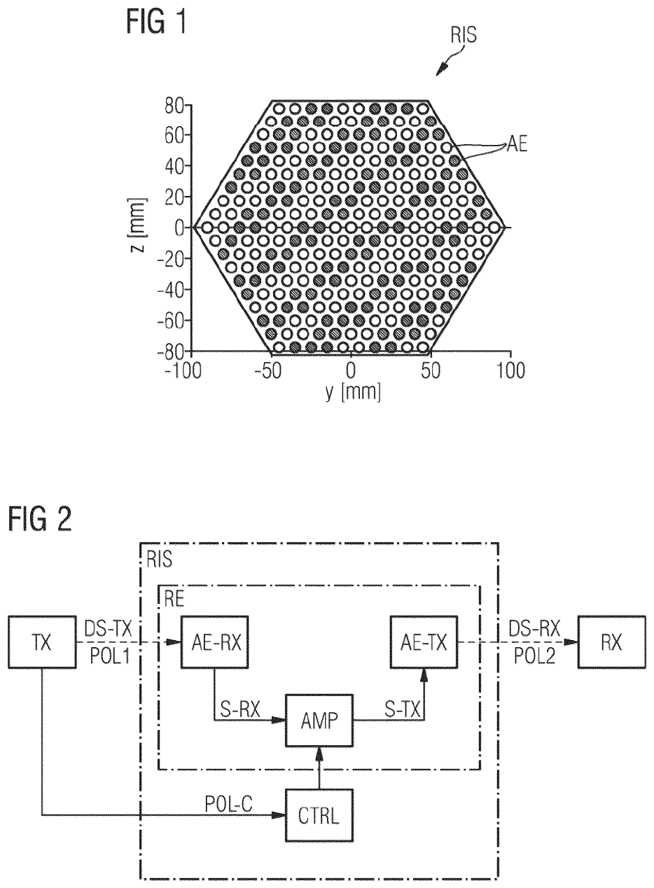

FIG. 1 symbolically illustrates an exemplary electronically controllable reflector RIS having a plurality of circular antenna elements AE that are arranged on a planar circuit substrate in a hexagonal pattern.

FIG. 2 shows a block diagram of the electronically controllable reflector RIS and a wireless communication system.

The electronically controllable reflector RIS comprises a plurality of reflector elements RE, each comprising a receiving antenna element AE-RX and a transmitting antenna element AE-TX. A reflector RIS can comprise a plurality of reflector elements RE.

Each reflector element RE has a first antenna element AE-RX, which is configured to receive a signal DS-TX transmitted by a transmitter TX as a receive signal with a first polarization POL1, where the receive signal is provided as the input signal S-RX.

In addition, an amplifier device AMP is provided, which is configured to electronically amplify the input signal S-RX and output it as an output signal S-TX to the transmitting antenna element AE-TX.

Each reflector element RE has a second antenna element AE-TX which is configured to transmit the output signal S-TX with a second polarization POL2 as a transmit signal DS-RX to a receiver RX.

In addition, a control device CRTL is provided which is configured to control the output signal S-TX in magnitude and/or phase using electronic control means to form a controllable antenna characteristic of the reflector and so that the second polarization POL2, for example, a vertical polarization, differs from the first polarization POL1, for example, a horizontal polarization.

The amplifier device AMP can be incorporated in a reflector element RE.

The reflector RIS is preferably dimensioned to operate at an operating frequency of at least 20 GHz.

The first antenna element AE-RX and the second antenna element AE-TX are optionally formed by a common antenna structure AE which, together with the amplifier device AMP, forms the reflector element RE.

The amplifier device AMP may comprise a bidirectional signal amplifier.

In a specific exemplary embodiment, the amplifier device AMP is controlled such that the antenna element AE-RX or AE-TX providing the better transmission quality of the signal DS-TX with polarization POL1 is used as the receiving element. At the same time, the respective other antenna element AE-TX or AE-RX is used to transmit the signal DS-RX with polarization POL2. The setting or control can optionally be performed using a control signal POL-C transmitted by the transmitter TX. In FIG. 1, the control POL-C of the system control device CTRL is shown separately from the data transmit signal DS-TX. This representation is only a logical depiction, because the data transmit signal DS-TX and the polarization control signal POL-C can optionally be transmitted via the same wireless channel, or alternatively via separate transmission channels.

In another exemplary embodiment, a system comprises a radio transmitter TX for transmitting a data transmit signal DS-TX with electronic means for controlling the polarization POL1 of the data signal, an electronically controllable reflector RIS in accordance with the invention for reflecting the data transmit signal DS-TX, a radio receiver RX for receiving the reflected data signal DS-RX, and a system control device CTRL.

The system control device CTRL is configured to set the polarization POL2, using the respective electronic means for setting the polarization, when the data signal DS-RX is transmitted at the reflector RIS.

Electronic means for setting the polarization are known in the prior art, such as the use of separate feed points on a corresponding antenna, such as a patch antenna, or using orthogonally arranged dipole antennas.

The radio transmitter TX can also be configured to transmit a first data signal with a first polarization at a first point in time and to transmit a second data signal with a second polarization at a subsequent second point in time, where the second polarization differs from the first polarization.

The controllable reflector can be configured to reflect the first and second data signals to the radio receiver, which receives both signals.

The system shown represents only a unidirectional signal path from the transmitter TX via the reflector RIS to the receiver RX. However, it is clear that the system can also operate bidirectionally, and that the transmitter TX and the receiver RX can, in each case, be implemented as a transceiver capable of transmitting and receiving data. This also implies that the system control device CTRL is controlled, in the appropriate transmit mode, by the transmitter of the transceiver incorporating the receiver RX. In other words, the system control device CTRL can optionally be connected both to the transceiver of the transmitter TX and to the transceiver of the receiver RX. For improved clarity, however, this functionality is not illustrated,

It is also advantageous if the RIS is connected to only one of the transceivers, namely when the transceiver is part of a “base station.” In the base station, all the data relating to transmit and receive times as well as to the transmit directions (up/downlink) of all the participants is known.

In a specific exemplary embodiment, a system is provided comprising a radio transmitter TX for transmitting a data transmit signal DS-TX with electronic means for controlling the polarization POL1 of the data signal, an electronically controllable reflector RIS for reflecting the data transmit signal DS-TX, a radio receiver RX for receiving the reflected data signal DS-RX, and a system control device CTRL connected to the transmitter TX using a communication means.

The radio transmitter TX is configured to set a predetermined polarization POL1 using its electronic means and to transmit information about this polarization POL1 to the system control device CTRL using the communication means.

A predetermined polarization POL1 is set at the radio transmitter TX using its electronic means.

This polarization POL1 is transmitted to the system control device CTRL using the communication means.

The system control device CTRL is configured to set the polarization POL1 at the reflector RIS, using the respective electronic means for setting the polarization, when receiving the data signal DS-TX.

In another specific exemplary embodiment, a system is provided comprising a first radio transmitter TX and a second radio transmitter, as well as a first radio receiver RX and a second radio receiver.

The first radio transmitter TX and the first radio receiver RX form a first transceiver.

The second radio transmitter and the second radio receiver form a second transceiver.

A controllable reflector RIS is configured to connect the first transceiver to the second transceiver via a wireless link and the reflector RIS.

The first radio transmitter TX is configured to transmit a first data signal with a first polarization at a first point in time.

The second radio transmitter is configured to transmit a second data signal with a second polarization at a subsequent second point in time, where the second polarization differs from the first polarization.

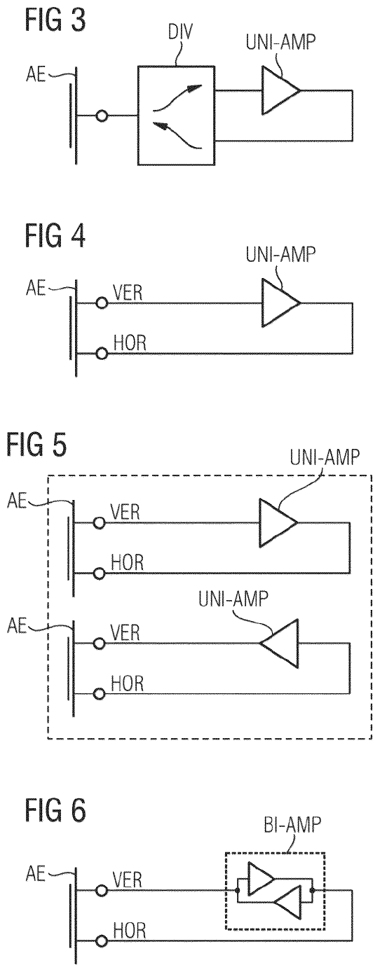

FIG. 3 shows an antenna element in accordance with the prior art.

An antenna element AE receives a signal, supplies the signal to a divider circuit DIV, amplifies the received signal with a unidirectional amplifier UNI-AMP, and supplies the amplified signal back to the antenna element AE via the divider DIV for onward radiation.

If the amplification provided by the amplifier UNI-AMP is set too high, undesirable oscillation of the arrangement may occur.

FIG. 4 shows an exemplary embodiment of an antenna element with an inserted unidirectional amplifier and two antenna ports for different polarizations.

An antenna element AE receives a signal via a first feed port, which only detects a vertical polarization plane VER, amplifies the received signal with a unidirectional amplifier UNI-AMP, and supplies the amplified signal back to the antenna element AE for radiation, but via a second feed port with a horizontal polarization plane HOR different from the polarization plane VER of the first feed port.

The vertical polarization plane VER corresponds to the first polarization POL1 according to the preceding figures, and the horizontal polarization plane HOR corresponds to the second polarization POL2 as shown in the preceding figures, which differs from the first polarization POL1.

FIG. 5 shows an exemplary embodiment of two antenna elements, each with an inserted unidirectional amplifier and two antenna ports for different polarizations HOR and VER.

The arrangement corresponds to a doubled version of the arrangement according to the preceding figure, but a separate signal path is provided for two different polarization planes HOR and VER.

FIG. 6 shows an exemplary embodiment of an antenna element with an inserted bidirectional amplifier BI-AMP and two antenna ports for different polarizations of a common, combined antenna AE, where the bidirectional amplifier BI-AMP provides a single signal path for both feed ports for a first horizontal and a second vertical polarization plane HOR and VER.

The bidirectional signal amplifier BI-AMP can be implemented, for example, by two unidirectional amplifiers connected in antiparallel using controllable switches, i.e., two unidirectional amplifiers connected to one another in an antiparallel and switchable manner via two RF switches (SPDT, “single pole, double throw”).

In other words, the nodes of the bidirectional amplifier BI-AMP shown in FIG. 6 can each be replaced by SPDT switches and controlled accordingly to set only one active amplification direction of the bidirectional signal amplifier BI-AMP.

Alternatively, the two antiparallel-connected unidirectional amplifiers of the bidirectional signal amplifier BI-AMP can each be operated by activation or deactivation in the respective branches, each containing a unidirectional amplifier, in order to switch the active amplification direction of the bidirectional signal amplifier BI-AMP.

This can be accomplished by applying or disconnecting a supply voltage, or by changing control voltages, for example, for setting the respective operating point at the respective unidirectional amplifier, in order to set only one active amplification direction of the bidirectional signal amplifier BI-AMP.

By changing the active amplification direction of the bidirectional signal amplifier BI-AMP, the changing of the polarization direction can be achieved.

The transmit path in the combined antenna AE thus becomes the receive path of the combined antenna AE, and the reception path becomes the transmission path of the combined antenna AE.

In the combined antenna AE for the two polarization planes HOR and VER, the first polarization direction HOR is provided for one switchable transmit/receive path, and the second polarization direction VER is provided for the second switchable transmit/receive path, where the first polarization direction HOR differs from the second polarization direction VER, where the first polarization direction HOR and the second polarization direction VER are preferably orthogonal to one another.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements that perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form embodiment as a general matter of design choice. It is the intention, therefore, to be limited only as indicated by the scope of the claims appended hereto.

1.-6. (canceled)

7. An electronically controllable reflector, comprising:
a plurality of reflector elements, each reflector element comprising:
a first antenna element configured to receive a received signal as an input signal with a first polarization,
an amplifier device configured to electronically amplify the input signal and output said applied input signal as an output signal, and
a second antenna element which is designed to transmit the output signal with a second polarization as a transmit signal, the second polarization differing from the first polarization; and
a control device configured to utilize electronic means to control at least one of a magnitude and phase of the output signal to form a controllable antenna characteristic of the reflector;
wherein the control device is further configured to receive a provided polarization control signal;
wherein the amplifier device comprises a bidirectional signal amplifier having two adjustable amplification directions and is configured to set an active amplification direction of the bidirectional signal amplifier according to the polarization control signal.

8. The reflector as claimed in claim 7, wherein the reflector is configured to operate at an operating frequency of at least 20 GHz.

9. The reflector as claimed in claim 7, wherein the at least one first antenna element and the at least one second antenna element are formed by a common antenna structure.

10. The reflector as claimed in claim 8, wherein the at least one first antenna element and the at least one second antenna element are formed by a common antenna structure.

11. A system comprising:
a radio transmitter for transmitting a data transmit signal;
electronic means for controlling polarization of the data transmit signal;
an electronically controllable reflector for reflecting the data transmit signal as claimed in claim 7;
a radio receiver for receiving the reflected data signal, and
a system control device connected to the transmitter by a communication means;
wherein the transmitter is configured to set a predetermined polarization utilizing the electronic means and to transmit information about the predetermined polarization to the system control device via the communication means; and
wherein the system control device is configured to set the polarization at the reflector, utilizing a respective electronic means for setting the polarization, when receiving the data signal.

12. The system as claimed in claim 10, further comprising:
a first radio transmitter according to the system as claimed claim 4 and a second radio transmitter;
a first radio receiver according to the system as claimed in claim 4 and a second radio receiver, the first radio transmitter and the first radio receiver forming a first transceiver, and the second radio transmitter and the second radio receiver forming a second transceiver; and
a controllable reflector according to the system as claimed claim 4, the controllable reflector being configured to connect the first transceiver to the second transceiver via a wireless link via the reflector;
wherein the first radio transmitter is further configured to transmit a first data signal with a first polarization at a first point in time, and the second radio transmitter is configured to transmit a second data signal with a second polarization, different from the first polarization, at a subsequent second point in time.

13. The system as claimed in claim 10, wherein the transmitter is configured to transmit polarization information relating to the first polarization to the controllable reflector; and wherein the reflector controllable reflector is further configured to receive the polarization information and to set the amplification direction of the bidirectional signal amplifier to the first polarization.
